(19) United States
(12) Patent Application Publication
(10) Pub. No.: US 2009/0327951 A1
(43) Pub. Date: Dec. 31, 2009

(54) COMPUTER PROGRAM PRODUCT FOR MAINTAINING AN OBJECT PATH WITHIN A VIEW WINDOW

(75) Inventors: Anthony W. Erwin, Rochester, MN (US); Timothy C. Mossing, Fishers, IN (US); Brian O. Wood, Byron, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/163,874

(22) Filed: Jun. 27, 2008

(51) Int. Cl. G06F 3/048

(52) U.S. Cl. 715/785

(57) ABSTRACT

A computer program product for maintaining an object path within a view window that causes a computer to recognize an object path in response to an action to select the object path for viewing within a view window of a display including a first point in the object path, and position a second point in the object path within the view window in response to an action to navigate the view window in a direction from the first point toward the second point.

### BACKGROUND OF THE INVENTION

1. Field of the Invention

This invention relates generally to computer graphics processing, and particularly to a computer program product for maintaining an object path within a view window.

2. Description of Background

Computer programs that display and/or allow users to interact with topologies or other related items (“objects”), such as graphically represented computer system resources or elements of a road map, are becoming increasingly widespread and important. Such “maps” can be very effective in helping a user to quickly comprehend the relationships between a set of elements (such as computer system nodes or road map locations). However, these maps can also become quite complex and difficult to review regardless of the layout arrangement that is used. For example, in a practical computer system topology map, there may be numerous related nodes (e.g., hundreds or more) that are arranged in a layout that forms a “path” of the nodes (e.g., adjacent to or surrounding a central node). As another example, in a road map (or other geographical map), two or more locations may be connected by a road, waterway, etc. In such examples, a view window (or view port) may be provided to focus on a portion of such node path, e.g., to review properties of the nodes and/or their relationships. However, such view windows are usually capable of panning (or possibly scrolling) in a particular direction (e.g., up, down, left, or right) without respect to the layout of the node path. Thus, for example, a user may need to randomly pan or scroll the view window in various preset directions in an attempt to follow the path and review the nodes. In a computer system topology map that has numerous nodes (or nodes that are spread far apart), such restricted movement of the view window often results in the node path not remaining within the view window, thereby making it difficult to efficiently review the nodes. Therefore, the capability to maintain such object paths within a view window while the view window is navigated along the paths is desirable.

### SUMMARY OF THE INVENTION

A computer program product for maintaining an object path within a view window is provided. An exemplary embodiment of the computer program product causes a computer to recognize an object path in response to an action to select the object path for viewing within a view window of a display including a first point in the object path, and position a second point in the object path within the view window in response to an action to navigate the view window in a direction from the first point toward the second point.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured for maintaining an object path within a view window.

FIG. 2 is an exemplary display view of an object path maintained within a view window generated, for example, by the exemplary computing device of FIG. 1.

FIG. 3 is an exemplary display view of an object path maintained within a view window and a list of information about the items of the object path, generated, for example, by the exemplary computing device of FIG. 1.

FIG. 4 is an exemplary display diagram of an object path maintained within a view window, for example, as introduced in FIG. 2.

FIG. 5 is a flow diagram illustrating an example of a method for maintaining an object path within a view window, which is executable, for example as a computer program product, on the exemplary computing device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a computer program product for maintaining an object path within a view window is provided. In accordance with such exemplary embodiments, the capability to maintain such object path within a view window while the view window is navigated along the path is provided, thereby overcoming the need to randomly pan or scroll the view window in preset directions in an attempt to navigate the path.

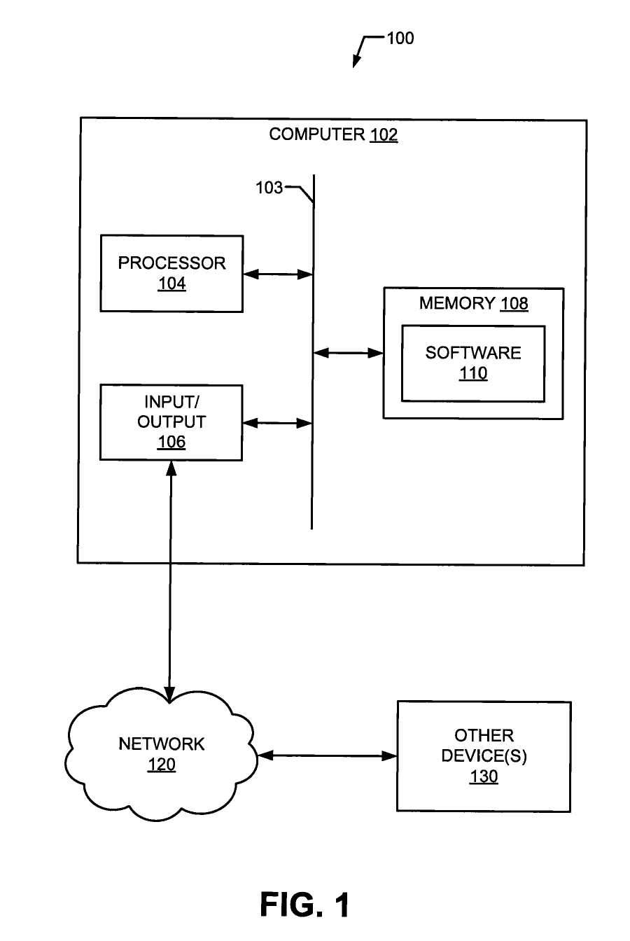

Turning now to the drawings in greater detail, wherein like reference numerals indicate like elements, FIG. 1 illustrates an example of a computer system 100 including an exemplary computing device (“computer”) 102 configured for maintaining an object path within a view window. In addition to computer 102, exemplary computer system 100 includes network 120, and other device(s) 130. Network 120 connects computer 102 and other device(s) 130 and may include one or more wide area networks (WANs) and/or local area networks (LANs) such as the Internet, intranet(s), and/or wireless communications network(s). Other device(s) 130 may include one or more other computing devices, such as one or more server devices, client devices, storage devices, etc. Computer 102, and other device(s) 130 are in communication via network 120, e.g., to communicate data between them.

Exemplary computer 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computer 102, such as a display, keyboard, modem, network adapter, ports, etc. (not depicted). Memory 108 includes software 110 configured for maintaining an object path within a view window, which is executable, e.g., by computer 102 via processor 104. Memory 108 may include other software, data etc. (not depicted). An exemplary operation of computer 102 executing software 110 will be described below.

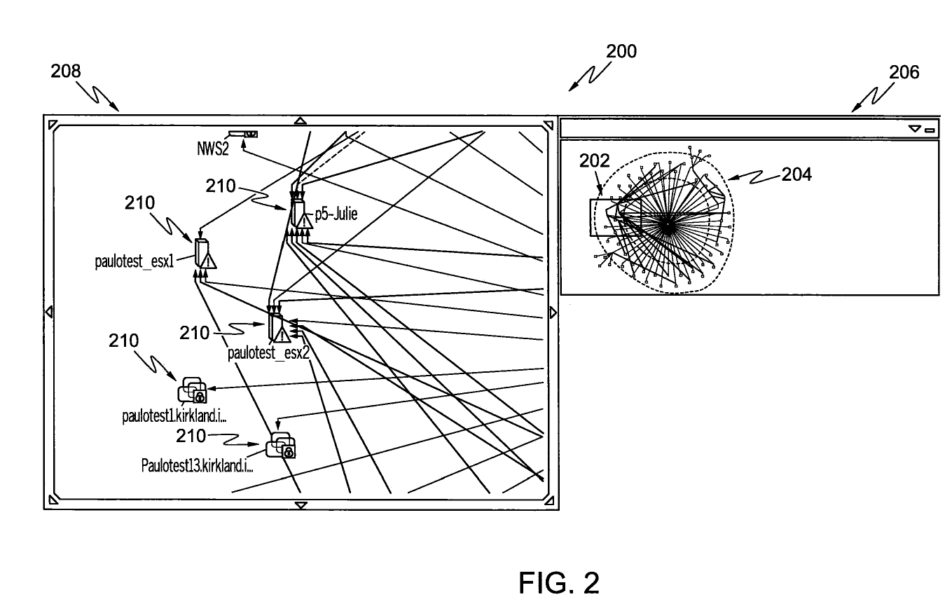

FIG. 2 is an exemplary display view 200 of an object path 204 maintained within a view window 202 generated, for example, by exemplary computer 102 of FIG. 1. View window 202 (which may also be referred to as a “view port” or “zoom window”) and object path 204 are displayed within an exemplary overview window 206 (which may also be referred to as a “pan window” or “extent window”). Display view 200 may also include a main window 208 (which may also be referred to as a “main view window” or a “zoom view window”), which can display a larger view of the content of view window 202. Object path 204 includes a plurality (e.g., two or more) of graphically represented related items 210, such as a plurality of nodes of a computer system topology (as depicted in FIG. 2), a plurality of elements of a map (e.g., a geographical map), etc. For example, the plurality of nodes 210 of object path 204 may be interconnected and/or connected to a common central node (e.g., representing a server or other computing device, not depicted). As another example, in a displayed map (not depicted), items 210 may represent a plurality of locations, addresses, and/or other map elements, and object path 204 may be a route between such items 210. Object path 204 may have various shapes, sizes, configurations, etc. and may be continuous (e.g., as depicted), discontinuous, or a combination of such (e.g., continuous with one or more discontinuous branches). As further described below, in accordance with exemplary embodiments of the invention, object path 204 is maintained within view window 202 when object path 204 is selected for viewing in view window 202 and action is taken to navigate view window 202 (e.g., by a user of computer 102).

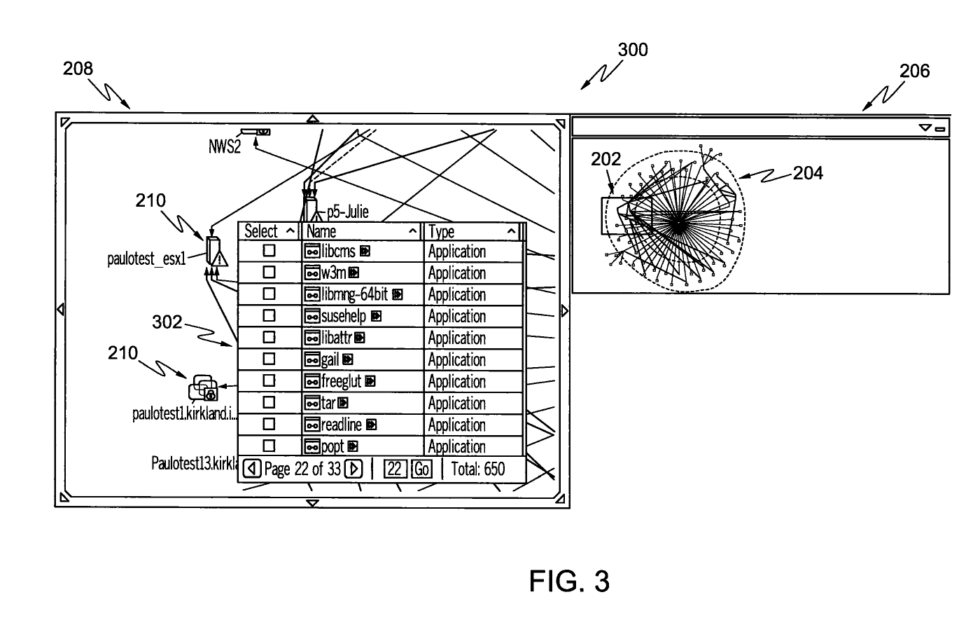

FIG. 3 is an exemplary display view 300 of an object path 204 maintained within a view window 202 and a list of information (“list”) 302 about the items 210 of the object path 204, generated, for example, by exemplary computer 102 of FIG. 1. Exemplary display view 300 includes view window 202, object path 204, overview window 206, main window 208, and items 210, which were described above with respect to display view 200 of FIG. 2. Additionally, display view 300 includes list 302, which is a list of information about items 210 of object path 204. For example, in the case of an object path 204 of computer system topology nodes, such information may include a name, type, etc. regarding the nodes. As another example, in the case of an object path 204 of map elements, such information may include a location name, address, etc. regarding the map elements. List 302 can be displayed, e.g., within overview window 206, main window 208, or otherwise within display view 300 (e.g., within a separate window of a display). List 302 may include various formats, configurations, etc. For example, as depicted, list 302 may include multiple lines, rows, columns, etc. of information about items 210 of object path 204, which can be viewed, e.g., by an action to scroll through the information. As another example, list 302 may include multiple pages of such information (e.g., that each include a number of lines, rows, columns, etc.), which can be viewed, e.g., by an action to page through the information (e.g., sequentially or directly). As further described below, in accordance with exemplary embodiments of the invention, when action is taken to scroll or page through list 302 (e.g., by a user of computer 102), view window 202 is navigated during and object path 204 is maintained within view window 202. For example, when a row, column, etc. of list 302 is scrolled to or paged to, view window 202 is navigated to the corresponding item 210 (e.g., for which information in list 302 is selected, highlighted, etc.) while object path 204 is maintained within view window 202.

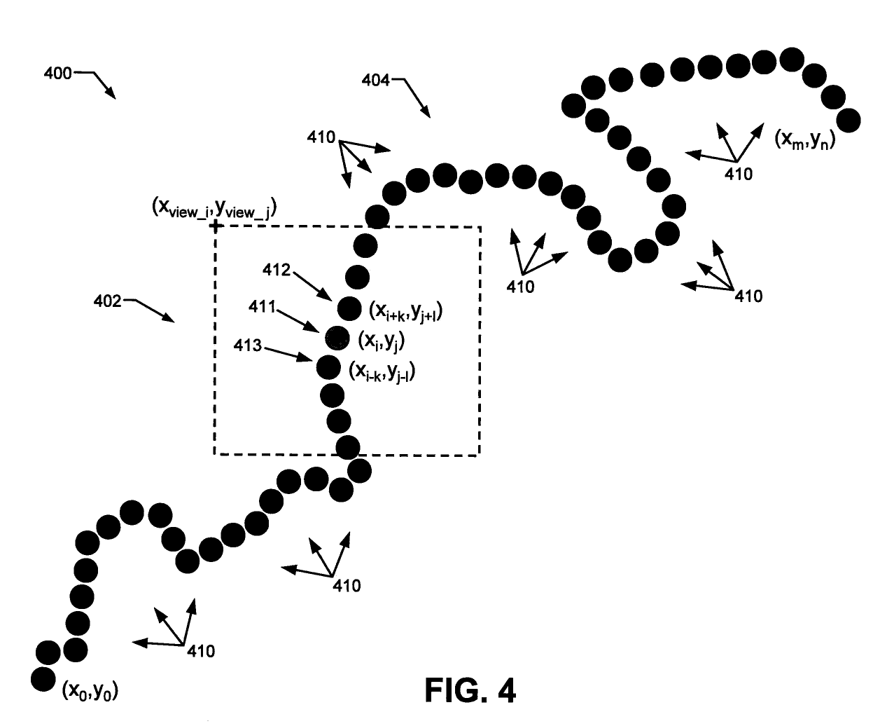

FIG. 4 is an exemplary display diagram 400 of an object path 404 maintained within a view window 402, for example, as introduced in FIG. 2. Object path 404 includes a plurality of items 410, which in diagram 400 may represent graphically represented related items, points (e.g., pixels or other graphic display elements), or a combination of such. Items 410 have coordinates, locations, etc. (e.g., within a display or display window) represented by “xᵢ,yⱼ”, e.g., where “xᵢ” may be a horizontal coordinate and “yⱼ” may be a vertical coordinate (where, e.g., i=1, 2, 3, . . . , m, and j=1, 2, 3, . . . , n). For example, a first item (or point) 411 may be located (e.g., centered) within view window 402 at coordinates xᵢ,yⱼ and a second item 412 may be located at coordinates xᵢ₊ₖ,yⱼ₊ₗ, adjacent to (e.g., above and/or to the right of) the first item 411 (where, e.g., k=1, 2, 3, . . . , m, and l=1, 2, 3, . . . , n). An alternate second item 413 may be located at coordinates xᵢ₋ₖ,yⱼ₋ₗ, adjacent to (e.g., below and/or to the left of) the first item 411. Furthermore, view window 402 (e.g., the origin, center, etc.) may be located at coordinates “x_{view}_{_{—}}ᵢ,y_{view}_{_{—}}ⱼ” (e.g., representing a horizontal coordinate and vertical coordinate respectively). Although items 412, 413 are depicted within view window 402, a next adjacent item to the first item 411 may be located outside of view window 402 in accordance with exemplary embodiments. As further described below, in an exemplary execution, when view window 402 is navigated in a direction from the first item 411, a second item (e.g., 412 or 413) in object path 402 is positioned (e.g., centered) in view window 402, thereby maintaining object path 404 within view window 402. For example, in response to an action to pan or scroll view window 402 in a direction from first item 411 to second item 412 (e.g., up and/or to the right), the new coordinates (x_{view}_{_{—}}ᵢ_{_{—}}ₙₑₓₜ,y_{view}_{_{—}}ⱼ_{_{—}}ₙₑₓₜ) of view window 402 may be determined according to the following:

x_{view}_{_{—}}ᵢ_{_{—}}ₙₑₓₜ=x_{view}_{_{—}}ᵢ+(xᵢ₊ₖ−xᵢ) (EQ1)

y_{view}_{_{—}}ⱼ_{_{—}}ₙₑₓₜ=y_{view}_{_{—}}ⱼ+(yⱼ₊ₗ−yⱼ) (EQ2)

As another example, in response to an action to pan or scroll view window 402 in a direction from first item 411 to alternate second item 413 (e.g., down and/or to the left), the new coordinates (x_{view}_{_{—}}ᵢ_{_{—}}ₙₑₓₜ,y_{view}_{_{—}}ⱼ_{_{—}}ₙₑₓₜ) of view window 402 may be determined according to the following:

x_{view}_{_{—}}ᵢ_{_{—}}ₙₑₓₜ=x_{view}_{_{—}}ᵢ+(xᵢ₋ₖ−xᵢ) (EQ3)

y_{view}_{_{—}}ⱼ_{_{—}}ₙₑₓₜ=y_{view}_{_{—}}ⱼ+(yⱼ₋ₗ−yⱼ) (EQ4)

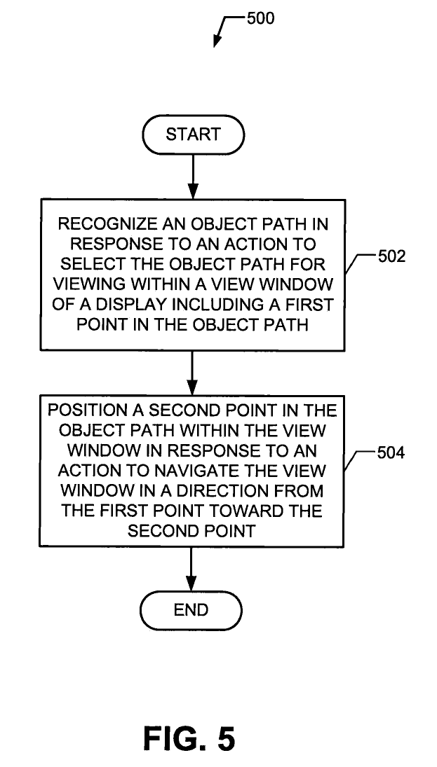

FIG. 5 illustrates an example of a method 500 for maintaining an object path within a view window, which is executable, for example, on the exemplary computer 102 of FIG. 1 (e.g., as a computer program product). Exemplary method 500 may also describe an exemplary operation of computer 102 executing software 110, which is configured for maintaining an object path within a view window. In block 502, an object path (e.g., 204, 404) is recognized in response to an action to select the object path for viewing within a view window (e.g., 202, 208, 402) of a display including a first point (e.g., 411) in the object path. The object path includes a plurality of graphically represented related items (e.g., 210, 410) and at least a portion of the object path is displayed in the view window. As further described above, the object path may, e.g., include a plurality of nodes of a computer system topology or a plurality of locations of a map. The action to select the object path for viewing may include one or more actions, commands, etc., e.g., via a computer keyboard, mouse, or other input/output component (e.g., 106).

The object path may be recognized (e.g., via computer 102), e.g., by the related items, points, etc. (e.g., 210) that form the object path (e.g., interconnected computer topology nodes or map locations) being identified, acknowledged, etc. so that they can be viewed via a navigation of the view window. For example, an object path that includes interconnected computer topology nodes (e.g., of a particular type, status, etc.) may be recognized in response to a selection of one or more of the nodes or a point, connecting element, etc. between them. Such criteria for the selection of the object path may be set by a user, administrator, etc. In some embodiments, a first point in the object path may be centered within the view window in response to the action to select the object path (e.g., item 411 in view window 402). One or more of various methods, algorithms, etc. may be implemented to determine the point (item, node, etc.) to be centered and/or to center that point. For example, a closest point to a dimensional center of the view window may be centered by adjusting the location of the view window appropriately. Additionally, in some embodiments, an appearance of the object path may be highlighted in response to the action to select the object path. For example, computer 102 may cause the displayed appearance of the selected object path to be modified by bolding, coloring, or otherwise modifying the appearance (e.g., from a normal, previous, etc. condition).

In block 504, a second point in the object path is positioned within the view window in response to an action to navigate the view window in a direction from the first point (e.g., 410) toward a second point (e.g., 412 or 413). For example, in response to an action to navigate the view window in a direction from the first item to the second item, the coordinates (e.g., of an origin or other point), and thus the position, of the view window may be changed according to EQ1, EQ2, EQ3, and/or EQ4 (listed above). That is, e.g., the horizontal position of an origin of the view window may be changed from a first horizontal coordinate to a second horizontal coordinate, where the second horizontal coordinate is equal to a sum of the first horizontal coordinate plus a difference of a horizontal coordinate of the second point minus a horizontal coordinate of the first point. Similarly, the vertical position of the origin of the view window may be changed from a first vertical coordinate to a second vertical coordinate, where the second vertical coordinate is equal to a sum of the first vertical coordinate plus a difference of a vertical coordinate of the second point minus a vertical coordinate of the first point.

In some embodiments, the action to navigate the view window may include a command (action, input, etc.) to pan or scroll the view window in the direction from the first point to the second point, e.g., via a computer keyboard, mouse, or other input/output component. For example, with reference to FIG. 4, a command to pan or scroll view window 402 in an upward and/or rightward direction may cause the position of view window 402 to be moved (e.g., horizontally and/or vertically) from item 411 to item 412. Similarly, a command to pan or scroll view window 402 in a downward and/or leftward direction may cause the position of view window 402 to be moved from item 411 to item 413. In embodiments where the first point (item, node, etc.) is centered within the view window (as described above), such change in position of the view window may center the second point within the view window. Furthermore, one or more of various methods, algorithms, etc. may be implemented to correlate the action to navigate the view window with the item and/or direction to move the view window toward in order to determine the position change of the view window.

In some embodiments, a list of information (e.g., list 302 described above) may be generated in the display about the items of the object path in response to an action to request the information be displayed (e.g., a same or additional action to select the object path and/or one or more other actions via a computer keyboard, mouse, or other input/output component). In such embodiments, as further described above, the action to navigate the view window includes a command to scroll or page through the list (e.g., in addition or alternate to an action to pan, scroll, etc. the view window). In other embodiments, a zoom condition of the view window is adjusted to display an extent of the object path within the view window. For example, when an object path is selected for viewing within the view window, the size (e.g., width, height, etc.) of the view window (e.g., 202, 402) may be adjusted (e.g., increased, decreased, etc.) to fit an extent (e.g., width, height, etc.) of the object path, e.g., so that the extent of the object path can be viewed. Furthermore, the size of the view window may be further adjusted to fit the extent of the object path as it varies when the view window is navigated along the object path. As another example, the magnification of the displayed output of the view window (e.g., via a main window 208) is adjusted so that the extent of the object path is viewable, e.g., when the object path is selected and/or navigated. This adjusting of the zoom condition of the view window may be implemented through one or more of various methods, algorithms, etc. For example, this adjusting of the zoom condition of the view window may be correlated to the recognition of the object path (e.g., characteristics and/or locations of the items therein).

Exemplary computer system 100, computer 102, and displays 200, 300, 400 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary computer system 100 and computer 102, execution of the flow diagram blocks may be implemented with other hardware and/or software architectures that provide the same features, functions, etc. in accordance with exemplary embodiments of the invention.

Exemplary embodiments of the invention can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A computer program product for maintaining an object path within a view window, comprising a computer usable medium having a computer readable program, wherein the computer readable program, when executed on a computer, causes the computer to:
recognize an object path in response to an action to select the object path for viewing within a view window of a display, wherein the object path comprises a plurality of graphically represented related items and at least a portion of the object path is displayed in the view window including a first point in the object path; and
position a second point in the object path within the view window in response to an action to navigate the view window in a direction from the first point toward the second point, wherein positioning the second point within the view window comprises:
changing the horizontal position of an origin of the view window from a first horizontal coordinate to a second horizontal coordinate, wherein the second horizontal coordinate is equal to a sum of the first horizontal coordinate plus a difference of a horizontal coordinate of the second point minus a horizontal coordinate of the first point; and
changing the vertical position of the origin of the view window from a first vertical coordinate to a second vertical coordinate, wherein the second vertical coordinate is equal to a sum of the first vertical coordinate plus a difference of a vertical coordinate of the second point minus a vertical coordinate of the first point.

2. The computer program product of claim 1, wherein the object path comprises a plurality of nodes of a computer system topology or a plurality of locations of a map.

3. The computer program product of claim 1, wherein the action to navigate the view window comprises a command to pan or scroll the view window in the direction.

4. The computer program product of claim 1, wherein the computer readable program, when executed on the computer, further causes the computer to generate a list of information in the display about the items of the object path in response to an action to request the information be displayed, and wherein the action to navigate the view window comprises a command to scroll or page through the list.

5. The computer program product of claim 1, wherein the computer readable program, when executed on the computer, further causes the computer to adjust a zoom condition of the view window to display an extent of the object path within the view window.

6. The computer program product of claim 1, wherein the computer readable program, when executed on the computer, further causes the computer to center the first point in the object path within the view window in response to the action to select the object path.

7. The computer program product of claim 1, wherein the computer readable program, when executed on the computer, further causes the computer to highlight an appearance of the object path in response to the action to select the object path.
